(19) United States
(12) Patent Application Publication
(10) Pub. No.: US 2006/0091747 A1
(43) Pub. Date: May 4, 2006

(54) Magnetic sound transducer containing flat vibration motor

(76) Inventors: Tadao Yamaguchi, Isesaki-shi (JP); Takeshi Osaki, Isesaki-shi (JP); Kentaro Fujii, Isesaki-shi (JP); Naohisa Koyanagi, Isesaki-shi (JP)

Correspondence Address: JORDAN AND HAMBURG LLP, 122 EAST 42ND STREET, SUITE 4000, NEW YORK, NY, 10168, US

(21) Appl. No.: 11/141,734

(22) Filed: May 31, 2005

(30) Foreign Application Priority Data
Aug. 4, 2004 (JP) 2004-227499
Sep. 9, 2004 (JP) 2004-262364
Sep. 21, 2004 (JP) 2004-272899
Dec. 17, 2004 (JP) 2004-365770
Mar. 4, 2005 (JP) 2005-60470
Mar. 31, 2005 (JP) 2005-100983

(51) Int. Cl. H02K 7/06; H04R 9/06

(52) U.S. Cl. 310/81; 381/412

(57) ABSTRACT

A vibration motor and speaker device includes a speaker excitation magnet around a flat brushless vibration motor which acts as a speaker magnetic pole. the vibration motor has a case constituting motor housing that comprises a magnetic body on a lateral periphery, a ceiling portion made of a nonmagnetic body, and a detent torque generation part disposed on a bracket and receiving the magnetic field of a rotor magnet. The detent torque generation part is separated from the magnetic body portion of the motor housing thus reducing effects of the magnetic field of the speaker excitation magnet.

### BACKGROUND

The present invention relates to a magnetic sound transducer (commonly known as a micro speaker); more specifically, it relates to a so-called 2-in-1 device comprising a flat brushless vibration motor as silent alarm means.

A conventional device is constituted such that a pair of plate-like elastic bodies are supported by a frame body so as to oppose each other, a magnetic field generator comprising a yoke and magnet is attached to one plate-like elastic body, a ring-shaped moving voice coil is attached to the other film-film elastic body, the coil is disposed within the magnetic field of the magnetic field generator, and currents with different frequencies are applied in a switchable manner. Laid-open Japanese Patent Application H10-117472.

There is also a device wherein, as a vibration source, a cylindrical vibration motor in which an eccentric weight is disposed on an output shaft to obtain centrifugal vibrations is disposed in a lateral direction. Laid-open Japanese Patent Application 2001-103589.

However, with such a constitution, a magnetic sound transducer cannot be miniaturized.

To address this issue, there is a magnetic sound transducer having a cored type, that is, a radial air-gap type motor, incorporated therein. Laid-open Japanese Patent Application 2003-125474.

However, with such a constitution, because it is a cored type and a spindle is attached to an output shaft, it cannot achieve a low profile, and because it uses a brush commutator and a high-speed motor, it is not sufficiently durable for speaker life.

Such a magnetic sound transducer is affected more by the life of the motor of the silent alarm means, than by a speaker life; therefore, there is demand for a motor with a longer life and reduction in overall profile. In order to meet such market demands, a thin brushless motor is desirable.

However, such a thin brushless motor entails troublesome issues when integrated into a magnetic sound transducer. Specifically, in order to increase sound pressure, a magnet with a strong monopole magnetic field such as a neodymium magnet is used as a speaker excitation magnet; however, this greatly influences a rotor magnet on the motor side. Therefore, when such a magnet is used with a motor that uses a single Hall sensor for reasons of disposition and capacity, a detent generation member is adversely impacted, and there are start-up related problems.

### SUMMARY OF THE INVENTION

It is an object of the present invention to achieve thin design and extend product life by using as a motor a flat brushless vibration motor incorporating a drive circuit, and even while simply constituting a housing of such a motor to be in a return pass for a speaker magnetic field while ensuring that the magnetic field of an excitation magnet on the speaker side does not influence the motor side.

The present invention provides a first feature which includes a flat brushless vibration motor disposed in a center of a speaker housing, wherein an eccentric rotor and stator driving the eccentric rotor are accommodated in a motor housing formed of a case and bracket, the motor housing has a flange extending radially outward on a bottom edge thereof and is attached to the speaker housing at the flange, and the motor housing includes a magnetic body for receiving a magnetic field of the excitation magnet in such a manner that a lateral periphery of the motor housing faces a moving voice coil, and, at at least one portion thereof, means for avoiding influence from a magnetic field of the excitation magnet is provided.

An embodiment of the above invention comprises a ring-shaped moving voice coil disposed radially outward from the flat brushless vibration motor across a gap, a diaphragm to which one end of the moving voice coil is attached, and the outer periphery of which is attached to the speaker housing, and a ring-shaped excitation magnet disposed on the flange and across a gap from an outer periphery of the moving voice coil.

More specifically, a second feature provides as means for avoiding influence from a magnetic field of the excitation magnet, at least one part of the flat vibration motor housing may be nonmagnetic or weakly magnetic, and a separate magnetic body may be interposed between the motor outer periphery and the moving excitation coil.

Further, in a third feature of the present invention the above described separate magnetic body, may be constituted so that a bottom edge extends radially outward, and the excitation magnet is placed thereon.

Further, in a fourth feature of the present invention the flat brushless vibration motor can be achieved by a constitution comprising as an eccentric rotor an axial air-gap magnet having a plurality of magnetic pole pieces, a rotor case, also termed a rotor yoke, in which the magnet is fixed, a nonmagnetic eccentric weight disposed outwardly of the magnet and positioned on an outermost periphery of the eccentric rotor, and a shaft bearing portion disposed inwardly of the magnet, wherein the rotor yoke has a flat portion receiving a magnetic field of the magnet and an axial wall on an outer diameter side following the flat portion. The, magnet is such that a surface receiving a magnetic field is enclosed by the flat portion and outer diameter is enclosed by the axial wall on the outer diameter side. A stator driving the eccentric rotor includes a shaft support portion supporting the eccentric rotor, a plurality of air-core armature coils disposed at a periphery of the shaft bearing portion so as to oppose the eccentric rotor across an axial gap and a stator base in which an IC drive circuit member driving the air-core armature coils is disposed.

Further, in a fifth feature of the present invention means for avoiding influence from a magnetic field of the excitation magnet can be achieved by means such that at least a part of a ceiling portion of a case constituting the motor housing is formed of a nonmagnetic or weakly magnetic body, and is adhesively bonded with a magnetic body on the lateral periphery.

More specifically, in a sixth feature of the present invention the flat brushless vibration motor can be achieved by comprising as an eccentric rotor an axial air-gap magnet having a plurality of magnetic pole pieces, a rotor yoke in which the magnet is fixed, a nonmagnetic eccentric weight disposed outwardly of the magnet and positioned on the outermost periphery of the eccentric rotor, and a shaft bearing portion disposed inwardly of the magnet, wherein the rotor yoke has a flat portion for receiving a magnetic field of the magnet and an axial wall on the outer diameter side following the flat portion, the magnet is such that the surface receiving a magnetic field is enclosed by the flat portion and the outer diameter is enclosed by the axial wall on the outer diameter side, as a stator driving the eccentric rotor, there are provided a shaft support portion supporting the eccentric rotor, a plurality of air-core armature coils disposed on the periphery of the shaft support portion so as to face the eccentric rotor via an axial gap, and a stator base in which an IC drive circuit member driving the air-core armature coils is disposed.

Further, in a seventh feature of the present invention alternative means for avoiding influence from a magnetic field of the excitation magnet can be achieved by a constitution wherein, as means for avoiding influence from a magnetic field of the excitation magnet, a ceiling portion of a case constituting the flat vibration motor housing has an inner concaved portion extending in the axial direction and having a diameter roughly equivalent with, or slightly larger than, an outer diameter of an axial air-gap magnet incorporated therein.

More specifically, in an eighth feature of the present invention an auxiliary plate for an eccentric rotor is accommodated on an exterior convex portion corresponding to the inner concaved portion so that an eccentric weight is partially held down by an outer periphery of the auxiliary plate.

In a ninth feature of the present invention means for avoiding influence from a magnetic field of the excitation magnet, can be achieved by the eccentric rotor comprising a magnetic balance concentric with a rotation center of the motor and outward of the magnet.

In a more specific configuration for magnetic balance means of a tenth feature of the present invention, magnetic balance means is a brim portion protruding from a rotor yoke along an entire periphery in the radial direction, and an arc-shaped non-magnetic eccentric weight is attached to a portion of the brim portion by combining a recess and protrusion.

In an eleventh feature of the present invention a motor, can be achieved by an eccentric motor comprising an axial air-gap magnet having a plurality of magnetic pole pieces, a rotor yoke in which the magnet is fixed, a nonmagnetic eccentric weight with a specific gravity of at least 17 disposed outward of the magnet, and a bearing disposed inward of the magnet, wherein the rotor yoke has a flat portion receiving the magnetic field of the magnet and an axial wall on the outer diameter side following the flat portion, the magnet is fixed to the flat portion such that a surface receiving a magnetic path is enclosed by the flat portion and the outer diameter is enclosed by the axial wall on the outer diameter side, to attain magnetic balance, the eccentric weight and bearing are respectively partially pressed by an auxiliary plate configured so that the outer diameter is concentric to the rotation center, a stator base is provided on which are disposed a shaft supporting the eccentric rotor, a plurality of air-core armature coils driving the eccentric rotor across an axial gap and a drive circuit member, and a housing accommodating the foregoing is provided.

Yet another constitution of means for avoiding influence from a magnetic field of the excitation magnet of a twelfth feature, can be achieved by a constitution such that a detent torque generation part disposed on an end bracket side is magnetically separated from a magnetic field of the excitation magnet by a motor housing.

A specific constitution of the detent torque generation part of a thirteenth feature can be achieved by a detent torque generation part constituted such that a plurality of detent torque generation parts are provided radially from the center with a magnetization angle roughly equivalent to, or an integral multiple of, the angle of magnetic pole pieces of the axial air-gap magnet to be assembled, and as magnetic separation means, there is disposed a nonmagnetic end bracket constituting a bracket that is a part of a housing, a tip of which is separated from the magnetic members of the housing.

It is preferable that the nonmagnetic portion in a fourteenth feature comprise a detent torque generation member attached thereto.

It is preferable that as a fifteenth feature the nonmagnetic end bracket be thicker than the detent torque generation part and have a shaft support portion formed in center, the center of the detent torque generation part be press-fitted onto the shaft support portion, and a cut-off tip be embedded in the nonmagnetic end bracket.

Another means for avoiding influence from an excitation magnet of a sixteenth invention feature can be achieved by a constitution wherein the flat vibration motor comprises a detent torque generation member made from a magnetic plate and an end bracket to which the detent torque generation member is attached, the detent torque generation member further having attached thereto a shaft bearing portion disposed in the center, at least two detent torque generation parts disposed outwardly in the radial direction, and a stator base made from a printed wiring board; when the number of magnetic pole pieces of the rotor to be assembled is 2n (with n being an integer 2 or larger), at least two air-core armature coils single-phase wired and fixed to the stator base; a drive circuit member disposed on the stator base so as not to overlap with the air-core armature coils when seen from the plan view; and a stator in which a feed terminal for input to the drive circuit member is integrally provided with the stator base in the radial direction; wherein the rotor comprises an axial air-gap magnet having a plurality of magnetic pole pieces and a rotor yoke holding the magnet, is rotatably fitted to the stator via a shaft, and is accommodated in a housing comprising a case having a magnetic body at a lateral periphery thereof and the brackets; a detent torque generation part extends in the axial direction to within the air-core armature coils integrally from the yoke bracket, and as means for avoiding influence from the magnetic field of the excitation magnet, the detent torque generation part is separated from the magnetic portion of the case lateral periphery.

With the invention according to the first feature, a flat brushless vibration motor can be easily attached to a speaker housing by a flange, and while a magnetic body disposed on the side serves as a magnetic pole piece for receiving the magnetic field of an excitation magnet of the speaker, the magnetic field of the excitation magnet on the speaker side does not affect the motor.

With the invention according to the second feature, a magnetic field of an excitation magnet on the speaker side is received by a magnetic body and a nonmagnetic portion functions in a manner similar to a gap, reducing influence on an axial air-gap magnet on the motor side.

With the invention according to the third feature, a closed magnetic path of an excitation magnet is configured, decreasing leakage flux and stopping influence on the motor side interior.

With the invention according to the fourth feature, an axial air-gap magnet is fixed so as to be enclosed by a rotor yoke, attaining sufficient fixing strength. When a rotor rotates, a weight is positioned on the outermost periphery of the rotating sphere, and the ring-shaped magnet and the rotor yoke serving as a rotor yoke forming the magnetic path for the magnet are separated from a cylindrical portion of a speaker yoke by the length of such weight. Thus the rotor is not influenced by the cylindrical portion that is a magnetic body.

In other words, because the rotor yoke and ring-shaped magnet are separated from such a cylindrical speaker yoke by the length of the weight in the radial direction of the rotor, the rotation outer periphery of the weight, which is necessary for a vibration motor, is used to eliminate influence on rotor rotation, enabling size reduction of a magnetic sound transducer.

With the invention according to the fifth feature, a nonmagnetic portion and a magnetic portion can be configured just with a case, and because a ceiling portion is nonmagnetic, leakage flux from a speaker excitation magnet cannot get around the case ceiling portion, eliminating influence on an axial air-gap magnet on the motor side.

With the invention described above, according to the sixth feature, because the shape of a speaker vibration foil plate is skillfully employed, without sacrifice of overall thickness, there is separation between case and axial air-gap magnet of an eccentric rotor, reducing influence from leakage flux from an excitation magnet. When a rotor rotates, a weight is positioned on the outermost periphery of the rotating sphere, a ring-shaped magnet and rotor case serving as a rotor yoke forming a magnetic path for the magnet are separated from a cylindrical portion of a speaker yoke by the length of the weight. Thus the rotor is not influenced by the magnetic cylindrical portion.

In other words, because the rotor yoke and ring-shaped magnet are separated from such a cylindrical speaker yoke by the length of the weight in the radial direction of the rotor, the rotation outer periphery of the weight, which is necessary for a vibration motor, is used to eliminate influence on rotor rotation, enabling size reduction of a magnetic sound transducer.

With the inventions according to the seventh and eighth features, sufficient space for disposing an auxiliary plate is secured without sacrificing thickness, and if the auxiliary plate is made magnetic, the magnetism of the axial air-gap magnet is improved. Also, even with a nonmagnetic metal plate, holding force for an eccentric weight and bearing is improved.

With the inventions according to the ninth and tenth features, even if some leakage flux from an excitation magnet manages to enter the motor side, because a magnetically balanced magnetic body is present, this leakage is received equally, eliminating influence on the magnet on the motor side. Because the magnetic balance is configured as a brim on the outer periphery of the rotor yoke, the magnet on the motor side is greatly separated from the motor housing, further eliminating influence and enabling easy attachment of a nonmagnetic eccentric weight.

With the invention according to the eleventh feature, a flat brushless vibration motor is configured so that influence from magnetic field leakage from an excitation magnet of a speaker is reduced, and strength of an eccentric weight and a bearing can be maintained.

With the inventions according to the twelfth and thirteenth features, influence from leakage flux from an excitation magnet on a detent torque generation part disposed on the end bracket side is reduced, stabilizing detent torque generation force.

With the invention according to the fourteenth feature, because a detent torque generation member is securely disposed and a nonmagnetic portion is metal, sufficient strength is maintained.

With the invention according to fifteenth feature, sufficient fixing strength of a shaft can be maintained, and a detent torque generation part can be easily and securely disposed.

With the invention according to sixteenth feature, influence from leakage flux from an excitation magnet of a speaker can be avoided, allowing an excitation magnet to function as a central magnetic pole.

Briefly stated, the present invention provides a flat brushless vibration motor constituting a speaker magnetic pole piece constituted so that, even as it receives a magnetic field of a speaker excitation magnet, this magnetic field leakage does not influence the motor interior. Specifically, it is constituted such that a case constituting a motor housing has a magnetic body on the lateral periphery, a ceiling portion is a nonmagnetic body, and a detent torque generation part disposed on the bracket side and receiving a magnetic field of a rotor magnet is separated from the magnetic body.

### BRIEF DESCRIPTION OF THE DRAWINGS

FIG. 1 illustrates a cross-sectional view of the first embodiment of a magnetic sound transducer of the present invention (embodiment 1);

FIG. 2 illustrates a cross-sectional view of the second embodiment of the same (embodiment 2);

FIG. 3 illustrates a cross-sectional view of the third embodiment of the same (embodiment 3);

FIG. 4 illustrates a plan view of the eccentric rotor of FIG. 3;

FIG. 5 illustrates a cross-sectional view of a modification of the embodiment of FIG. 3 (embodiment 4);

FIG. 6 illustrates a cross-sectional view of another embodiment of the present invention (embodiment 5);

FIG. 7 illustrates a plan view of an essential portion on the bracket side of FIG. 6;

FIG. 8 illustrates a cross-sectional view of an essential portion of a modification of FIG. 6 (embodiment 6);

FIG. 9 illustrates a cross-section of another embodiment of the present invention (embodiment 7); and

FIG. 10 illustrates a plan view of the stator side of FIG. 9.

### DETAILED DESCRIPTION

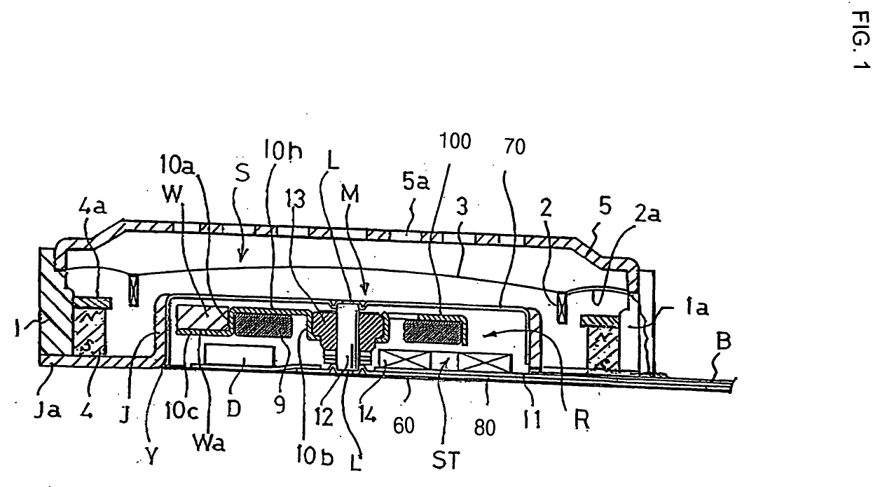

Referring to FIG. 1, a magnetic sound transducer S of a first embodiment of the present invention comprises a speaker housing 1 in the form of a shallow cylinder made of resin, a flat vibration motor M disposed in the center thereof and having an eccentric rotor incorporated therein, a ring-shaped moving voice coil 2 facing a radial outer periphery of the motor across a gap and formed as a multilayer solenoid type, a film-like diaphragm 3 made of a synthetic resin to which one end of the coil is attached and the outer periphery of which is attached to the housing, and a ring-shaped excitation magnet 4 disposed in the housing in a gap with respect to an outer periphery of the moving voice coil 2. A terminal 2a of the moving voice coil 2 is made to conform to the diaphragm 3 by adhesion or the like, and is led to a feed terminal B across a partial space 1a in the speaker housing 1 lateral surface.

These members are respectively covered with a cap 5 in the shape of an upside down dish which is attached to the speaker housing 1, which is made of a resin, at an outer periphery portion so as to hold down an outer periphery of the diaphragm 3. Here, the cap 5 is formed of nonmagnetic stainless steel, and a large number of sound output holes 5a are provided in order to lead audio generated from the diaphragm 3 to the outside. As the diaphragm 3 is extremely thin, it is indicated in the figures with a simple solid line.

The flat vibration motor M includes a single-phase Hall sensor to be described later, wherein as means for avoiding influence from a magnetic field of the excitation magnet 4, a motor housing, comprising a case 70 and bracket 60, is made nonmagnetic or weakly magnetic, and between the motor M and the moving excitation voice coil 2, there is provided a cylindrically formed magnetic body J with thickness of about that of the motor M and having a notch to partially lead a feed terminal.

This magnetic body J is configured so that a bottom portion thereof is fixed on the bracket 60 constituting the motor housing of the motor M uniformly or at a plurality of locations by laser welding indicated by Y. A flange Ja extends in a radial direction, a base end of the magnet 4 is attached thereto and the flange Ja is attached to a base end of the speaker housing 1 by an adhesive or the like so as to include a lead hole for the feed terminal B, thus supporting the motor M. Because this magnetic body J serves to reduce influence from magnetic field leakage from the speaker excitation magnet 4, it functions as a central magnetic pole piece for the excitation magnet 4, so that the leakage is received by the magnetic body J and prevented from entering into the motor M.

Because the flange Ja serves as a return pass plate for the excitation magnet 4, the flange J constitutes a closed magnetic path, reducing magnetic field leakage and preventing entrance thereof into the motor M.

The magnetic body J is configured so that a bottom portion is fixed on the bracket 60 of the housing of the motor M uniformly or at a plurality of locations by the laser welding indicated by Y, the flange Ja extends in a radial direction and is attached to the base end of the speaker housing 1 by an adhesive or the like so as to include a lead hole for the feed terminal B, thus supporting the motor.

On an upper portion of the excitation magnet 4, a yoke plate 4a covering an entire periphery of the magnet 4 is disposed, and a magnetic field directed to the moving coil 2 is focused. In other words, the magnetic body J functions to improve the effective magnetic flux density relating to the moving voice coil 2.

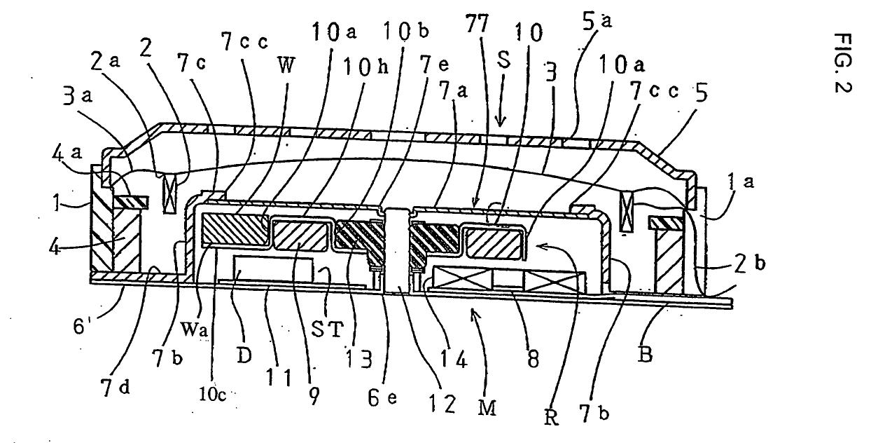

The motor M of a second embodiment of the present invention, as illustrated in FIG. 2, includes a Hall sensor type single-phase brushless motor. As is well-known, a single-phase brushless motor needs to have a rotor stopped at a prescribed position for automatic start. However, when a magnetic body is used for the bracket 60 and case 70 of FIG. 1, starting is difficult due to magnetic force of the large magnet; therefore, normally, the bracket needs to be nonmagnetic except for a detent torque generation part 80. When the thickness thereof is about 2 mm, then a thin rotor yoke holding a magnet must also be used, and leakage flux above, on the side opposite the gap, increases, so that the case 70 covering such a rotor needs to be nonmagnetic.

Referring to FIGS. 1 and 2, an eccentric rotor R is constituted such that an axial air-gap magnet 9 is adhered to a thin rotor yoke 10, 100. This thin rotor yoke 10, 100, which comprises a flat portion 10h receiving a magnetic field of the axial air-gap magnet 9, an outer diameter side axial wall 10a and an inner diameter side axial wall 10b integral with the flat portion 10h, is configured so as to enclose the axial air-gap magnet 9, thus achieving strong adhesion.

This thin rotor yoke 10, 100 is constituted such that two tongues 10c protrude horizontally in the normal line direction from the outer diameter side axial wall 10a and integrally therewith at a prescribed angle.

An arc-shaped eccentric weight W as shown in FIGS. 1 and 2 is constituted such that on one surface thereof recesses Wa for receiving the tongues 10c with thickness roughly equal to that of the tongues 10c are formed at positions corresponding to the tongues 10c. While the recesses Wa are respectively fitted with the tongues 10c on the outer diameter side axial wall 10a of the rotor yoke 10, 100, the eccentric weight W is fixed to the outer diameter side axial wall 10a by adhesion or the like. The tongues 10c (one shown in drawings) are formed in two normal line directions, thus restricting radial movement of the eccentric weight W. The outer periphery of the axial air-gap magnet 9 is covered with the axial wall 10a on a lateral periphery of the rotor yoke 10, 100, reducing leakage flux into the case 7, 70. Further, because there is a space to dispose the eccentric weight W, leakage flux of the axial air-gap magnet 9 radially outward does not reach outside of the case 7, 70 even when the case is nonmagnetic, and similarly provides means for avoiding influence from a magnetic field of the excitation magnet 4.

Therefore, since the magnetic body J of FIG. 1 is disposed on the outer periphery of the case 70, there is no influence on the rotation of the eccentric rotor R. The eccentric rotor R thus configured is rotatably fitted via a bearing 13 on a shaft 12 the base end of which is fixed by laser welding indicated by L in advance from the bracket side (here, in the center of the detent torque generation member 80). The shaft tip is also laser welded after the eccentric rotor R is fitted thereto. On the opening of the case 70 as well, the bracket side is also laser welded. Therefore, the motor has a monocoque construction, ensuring strength even with thin members.

A stator ST driving the eccentric rotor R comprises the detent torque generation member 80 attached to the nonmagnetic bracket 60 by spot welding or the like, two single-phase air-core armature coils 14 (only one is shown in the drawings) wired in series to each other and disposed on a stator base 11 comprising a flexible substrate thereabove, and a drive circuit member D disposed so as not to overlap with the coils 14. Because the drive circuit member D has a certain thickness, it is positioned at a location other than where the detent torque generation member 80 is located.

Therefore, because the drive circuit member D is incorporated in the motor M, the feed terminal part B needs only two terminals, one positive and one negative, meaning that together with the two conductive terminals of the moving voice coil 2, only four feed terminals are needed; thus the flat brushless motor M has an extremely simply constitution.

Referring to FIG. 2, a second embodiment is shown wherein the constitution of the magnetic sound transducer S is similar to that of the above described embodiment and identical members, including brushless motor M, are given the same reference symbols and explanation thereof is omitted.

This brushless motor M is characterized in that a case 77 is different from that of the above embodiment. This case 77 comprises a tube 7b formed of a magnetic material in a cylindrical shape and a flange 7d formed continuously with the bottom end of the tube 7b, and an outer periphery section of the flange 7d is fixed on the bottom end of the speaker housing 1. The excitation magnet 4 is attached to the speaker housing 1 and flange 7d.

The case 77 is constituted such that a lateral periphery portion thereof, together with the excitation magnet 4 and yoke plate 4a, forms a magnetic path for speaker that acts on the voice coil; it also serves as housing for the motor M. The flange 7d may be assembled as a separate body provided it is magnetically continuous with the tube 7b.

The upper end portions of the case 77 extend slightly toward the center, and a brim 7c is formed thereon. The brim 7c extends from the upper end of the tube 7b in an annular shape. As this brim 7c operates to pull in a magnetic flux from above generated from the magnet 4, the section serving as a yoke of the magnet 4 is expanded. Therefore, when using, for example, a thin motor M and the height of the cylindrical body 7b is not sufficient, the volume of a magnetic flux applied to the voice coil 2 can be increased.

On the brim 7c, a disk-shaped lid 7a is attached so as to cover the eccentric rotor R. This brim 7c and lid 7a form a ceiling portion of the case 77. The brim 7c and lid 7a are fixed by welding, crimping or the like, with the outer periphery of the lid 7a and is positioned by means of a step, for example, provided on the brim 7c. As means for avoiding influence from a magnetic field of an excitation magnet, the lid 7a is formed of nonmagnetic metal, resin material, or a stainless steel plate that is less magnetic than the tube 7b.

In the center of this lid 7a, a recess 7e for fixing one end of the shaft 12 is provided, and the shaft 12 is fixed therein by welding, press fitting or the like. Because the lid 7a is provided, the motor M is sealed, preventing infiltration of dust. Also, if the shaft 12 is fixed as in this embodiment, a fixed shaft type motor can be configured. The other end of the shaft 12 is attached to and fixed in a recess 6e of a bracket 6′, and laser welded from the outside as necessary.

In this embodiment, the inner periphery edge 7cc of the brim 7c is positioned in the radial direction within cylinder of rotation of the weight W, and the radial direction position of the inner periphery edge 7cc is further to the outer periphery than the outer diameter side axial wall 10a. With such a constitution, leakage flux from the rotor R is extremely low, so that the magnetic field does not affect the case 77 and rotation of the rotor is not prevented.

Also, because of this brim 7c, a magnetic field efficiently acts upon the moving voice coil 2. Alternatively, when the tube 7b is sufficient as a yoke, the lid 7a may be attached on the upper end of the tube 7b without needing to provide the brim 7c. In such a case, steps for forming a brim and the like are omitted.

Also, the tube 7b is positioned so as to be separated from the outer diameter side axial wall 10a by the length of the weight W. By using the weight W to separate the outer periphery side of the rotor R from the tube 7b, which is a magnetic body, influence on the rotor R by the tube 7b can be eliminated.

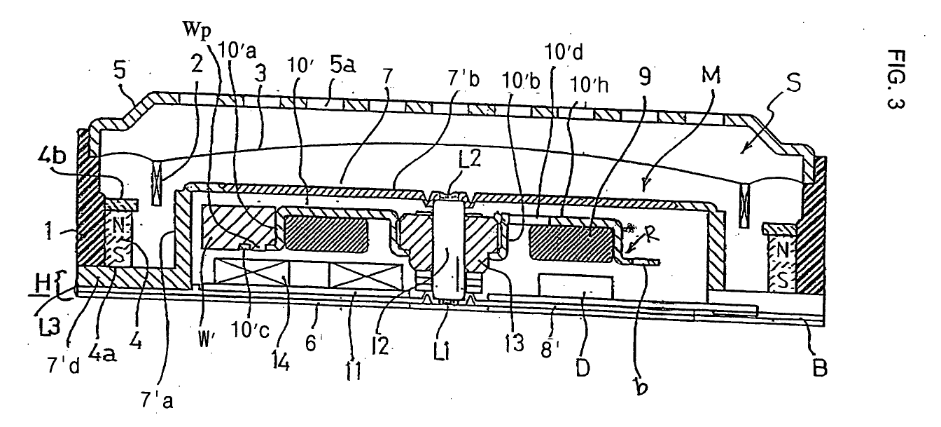

FIG. 3 illustrates a third embodiment, in which magnetic balance is attained on an eccentric rotor R. Here too, members identical to those of the above described embodiments are assigned the same reference symbols and explanation thereof is omitted.

The motor M constituting the present invention comprises a Hall sensor type single-phase brushless motor. As is well known, for purposes of automatic start, a single-phase brushless motor needs to have a rotor stop at a prescribed position. However, when a magnetic body is used for a bracket 6′ and case 7′, the magnetic force of the large magnet renders start difficult, and for this reason a large gap is required. Normally, however, to reduce motor size, the bracket 6′ needs to be a nonmagnetic body except for a detent torque generation part 8′. When a magnet with thickness of about 2 mm is used, the rotor yoke holding a magnet also must be thin, meaning that above, on the side opposite the gap, flux leakage increases, and the case 7′ covering such a rotor needs to be nonmagnetic. However, when the case 7′ is nonmagnetic, a magnetic path for the speaker excitation magnet 4 is not constituted; therefore, at least a lateral periphery section 7′a needs to be a magnetic body. Thus, in this embodiment, as means for avoiding influence from a magnetic field of an excitation magnet, only a ceiling portion facing the magnet 9 of the rotor R comprises a nonmagnetic stainless steel plate 7′b.

The eccentric rotor R is constituted such that a ring-shaped air-gap magnet 9 with a rectangular cross-section is adhesively bonded to a thin rotor yoke 10′. This thin rotor yoke 10′ is formed of a thin magnetic plate material, comprises a flat portion 10′h receiving a magnetic field of the axial air-gap magnet 9, an outer diameter side axial wall 10′a formed integral with the flat portion 10′h and in a cylindrical shape, and the cylindrical inner diameter side axial wall 10′b, also integral with the flat portion 10′h, for receiving the bearing 13, and is configured so that the flat portion 10′h and the outer diameter side axial wall 10′a enclose the axial air-gap magnet 9, ensuring that the magnet 9 is strongly adhered. The inner diameter side axial wall 10′b is formed in a cylindrical shape with a closed periphery and is concentric with the shaft 12, and is magnetically balanced. Therefore, the eccentric rotor R thus configured can receive a magnetic field from outside evenly and also receive magnetic leakage from the motor magnet 9 evenly.

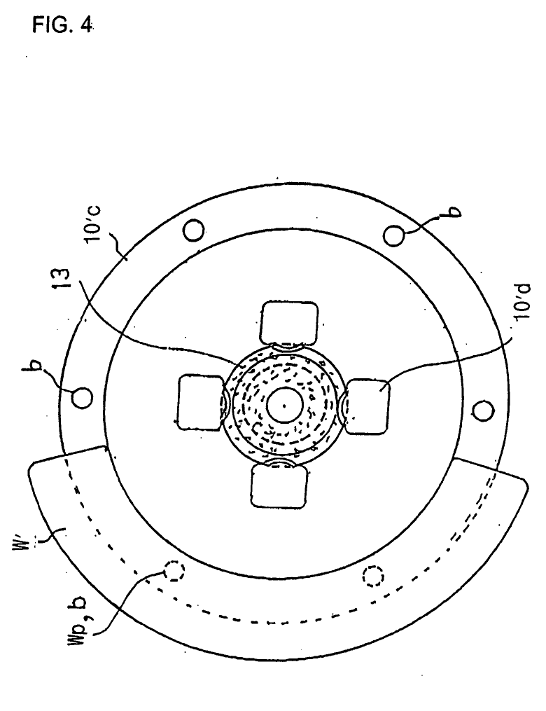

This thin rotor yoke 10′ is constituted such that a brim portion 10′c is formed in the radial direction along the entire periphery of the outer diameter side axial wall 10′a. This brim portion 10′c is configured so that its outer diameter is concentric to the rotation center, and as shown in FIG. 4, holes b into which projections Wp of the weight W′ are to be inserted are equidistantly provided along the same circumference. The holes b are provided as dummies at locations other than those to which the eccentric weight is to be attached in order to constitute magnetic balance means with respect to outside magnetic fields, and here six are equidistantly provided to correspond to the neutral sections of the axial air-gap magnet 9 magnetized into six magnetic pole pieces.

An arc-shaped eccentric weight W′ is placed on the brim portion 10′c so that, as described above, by combining recesses and protrusions, radial movement is restricted, and is fixed thereto by an adhesive agent or welding. The adhesive agent ensures that the rotor yoke 10′ is securely fixed to the lower surface and inner diameter surface of the arc-shaped weight, and by combining recesses and protrusions, radial movement of the weight W′ is restricted.

If the eccentric weight W′ and rotor yoke 10′ are attached with sufficient strength, it is not necessary to form the holes b. Alternatively, if there are holes b, the weight W′ can be attached with greater strength, and because the outer periphery of the brim portion 10′c is in a closed state and is formed in a circular shape concentric to the rotation shaft, magnetic balance of the rotor R is maintained despite the holes b.

The combining of recesses and protrusions may be reversed so that holes are provided on the weight W′ and projections provided on the brim portion 10′c. With this configuration, the weight W′ can be fixed more securely without having to provide holes in the brim portion 10′c, improving magnetic balance of the rotor and attaching strength of the weight.

The outer periphery of the axial air-gap magnet 9 is covered by the lateral periphery axial wall 10′a of the rotor yoke 10′, reducing flux leakage in the case 7′. Further, as there is a space for disposing the eccentric weight W′, radially outward leakage flux of the axial air-gap magnet 9 is prevented from leaking outwardly by the brim portion 10′c serving as a magnetic balance member, so there is no influence on the rotational action of the eccentric rotor R. The rotor yoke 10′ is configured so that a part of the inner diameter side axial wall 10′b is held at the bearing 13 by means such as crimping.

The eccentric rotor R thus configured is rotatably fitted, via the bearing 13, on the shaft 12, the base end of which having been fixed by laser welding at point L1 on the bracket side (here, in the center of the detent torque generation member 8′) in advance and from the outside. The shaft tip is also laser welded at point L2 after the eccentric rotor R is fitted thereto. The bracket side can also be laser welded at point L8 to the opening of the case 7′ as well. Therefore, the motor M employs a monocoque construction, so that strength can be secured even when thin members are used. The case 7′ and bracket 6′ may be assembled by publicly known means for crimping recesses and protrusions. In the drawings, 10′d are holes into which crimp teeth are to be inserted for fitting the bearing 13 onto the rotor yoke 10′ and crimping the edge of the bearing 13; so that there is no magnetic influence from an outside magnetic field, four such holes are provided equidistantly along the same circumference.

A stator driving the eccentric rotor R is driven by the detent torque generation member 8′ attached to the nonmagnetic bracket 6 by spot welding or the like, and, thereabove, two single-phase air-core armature coils 14 (only one is shown in the drawings) wired in series to each other and attached to the stator base 11 comprising a flexible substrate, and the drive circuit member D attached so as not to overlap with the coils 14.

Therefore, because the drive circuit member D is incorporated, the feed terminal part B needs only two terminals, one positive and one negative, and including the two conductive terminals of the moving voice coil 2, only four feed terminals are needed; therefore, the flat brushless motor M thus configured can have an extremely simple constitution.

In the motor M thus configured, a lower portion of the case 7′, constituting a part of a housing H, extends radially outward, serving as the flange 7′c, this flange portion is joined by welding or the like with the bracket 6 constituting the other portions of the housing H, a base portion 4a of the excitation magnet 4 is placed on the flange portion 7′c, and this flange 7′c is used for attachment to the speaker housing 1. In the drawings, 4b is a magnetic plate for causing the magnetic field of the excitation magnet 4, which is magnetized in the axial direction, to be directed in the radial direction toward the moving voice coil 2.

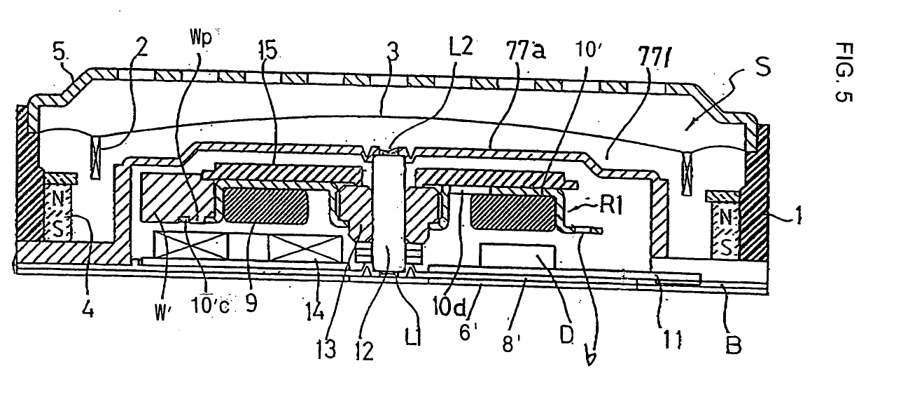

The embodiment of FIG. 5 is a variation of the embodiments of FIGS. 3 and 4, and elements identical to those in FIGS. 3 and 4 are assigned the same reference symbols and explanation thereof is omitted.

In view of a constitution of a speaker S in which a cross-section of a diaphragm is hill-shaped, a case 771 constituting a motor housing comprises a protruding convex portion 77a formed as one means for avoiding influence from a magnetic field of the excitation magnet 4 by forming an inner concavity. With such a constitution, a space on a side opposite a field gap widens, and there is no influence from leakage flux of the case top. Here, the protruding convex portion 77a is used and an auxiliary yoke plate 15 is attached to the flat portion 10′h of the rotor yoke 10′ with an adhesive or by spot welding; this auxiliary yoke plate 15 is designed so that, in addition to constituting a magnetic path, an outer diameter thereof is concentric to the rotation center, and this outer diameter partly holds down the eccentric weight W′, while the inner diameter side holds down the top of the bearing 13, thereby helping to ensure the strength of these members. Thus this constitution can withstand problems when, for example, the device is inadvertently dropped. As the auxiliary yoke plate 15 has an outer diameter concentric to the rotation center, magnetic balance with respect to an outside magnetic field is attained. In other words, an outside magnetic field, in this case, magnetic flux of the speaker excitation magnet 4, can be evenly received by the auxiliary yoke plate 15, even when leakage flux has passed through the motor housing, so that there is no influence on the rotor rotation.

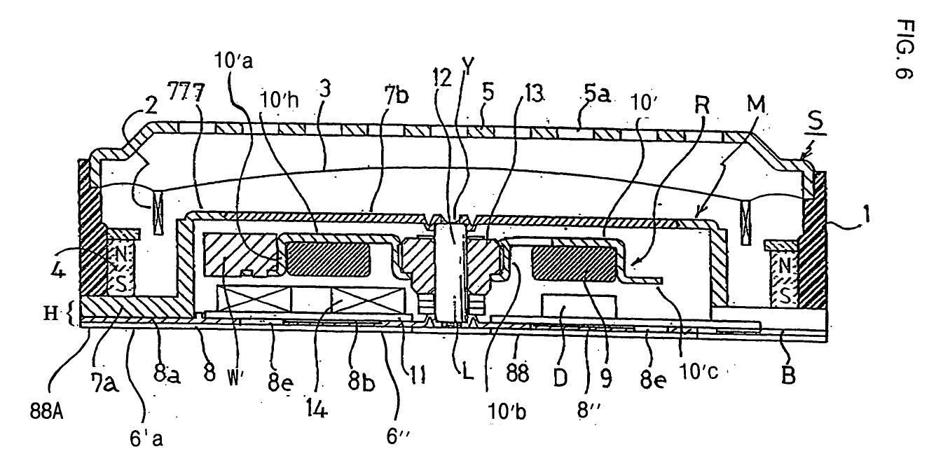

FIG. 6 illustrates an embodiment having a bracket-side means for avoiding influence from the magnetic field of the excitation magnet 4.

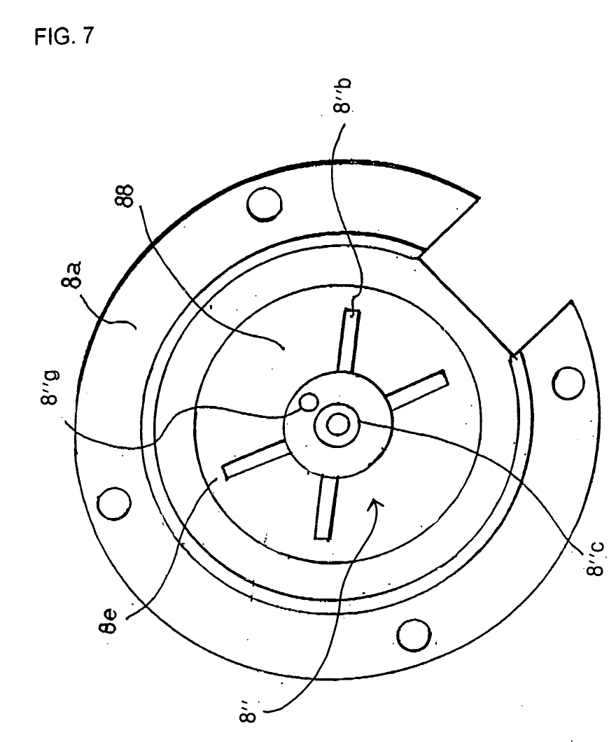

Specifically, as shown in FIGS. 6 and 7, the motor M constituting the present invention has a constitution as shown in FIG. 3, comprising a Hall sensor single-phase brushless motor. As is well known, for purposes of automatic start, a single-phase brushless motor needs to have the rotor R stopped at a prescribed position. However, when a magnetic body is used for the case 7 and bracket 6, the magnetism of the large magnet renders start difficult, and it is therefore necessary to have a large gap. Usually, however, to reduce motor size, for a bracket comprising part of a housing, the housing portion, other than the detent torque generation part 8, needs to be nonmagnetic.

For a magnet with thickness of about 2 mm, the rotor yoke holding the magnet must be thin, leakage flux above, from the side opposite the gap, increases. A case 777 covering such a rotor needs to be nonmagnetic. However, when the case 777 is nonmagnetic overall, a magnetic path of the speaker excitation magnet 4 is not formed. To remedy this problem, at least on a lateral periphery section, a magnetic body 7a is provided. Thus, in this embodiment, only a ceiling portion facing the magnet 9 of the rotor R has a nonmagnetic plate 7b set therein.

The motor M is constituted such that the case 777 constituting the housing H is made of magnetic material from the lateral periphery to the bottom portion, and in the radial direction a flange 7a is formed that overlaps and is integrated with a flange 6″a that extends from bracket 6″ in the radial direction. The bracket 6″ supports a detent torque generation member 8″ as an end bracket 88 formed of nonmagnetic metal.

As shown in FIG. 7, the detent torque generation member 8″ comprises thin detent torque generation parts 8″b for properly receiving the magnetism from the axial air-gap magnet 9 (described below). A flange 8a is integrated with a nonmagnetic end bracket 88, and a shaft fixing portion 8″c is provided in the center. The four detent torque generation parts 8″b, which are radially formed at angles roughly the same as, or an integral multiple of, that of the magnetic pole pieces (here, there are six magnetic pole pieces of the axial air-gap magnet, thus 60° and 120°), are attached to the nonmagnetic end bracket 88 using a 8″g by welding, adhesively bonding or the like so as to be positioned at prescribed locations. The speaker excitation magnet 4 is placed on the integrated flange 7a, 8a, and the flange 7a is used to attach the motor M to the speaker housing 1. In other words, this motor M is disposed in the speaker center, and serves as a magnetic pole receiving a monopole magnetic field of the excitation magnet 4.

This invention is characterized by a constitution such that a notch 8e is provided at the detent torque generation member 8″ as means for avoiding influence from magnetic flux of the excitation magnet 4, so that a magnetic field of the speaker excitation magnet 4 does not influence the detent torque generation part 8″. The notch 8e may be simply cut out from a piece including both the torque generation part 8″ and the flange 8a using a Thomson die cutter after integration with the nonmagnetic end bracket 88. Alternatively, it may be cut out together with the nonmagnetic end bracket 88.

With such a constitution, the detent function ensures that the stop action is stable as it depends only on the axial air-gap magnet on the motor side.

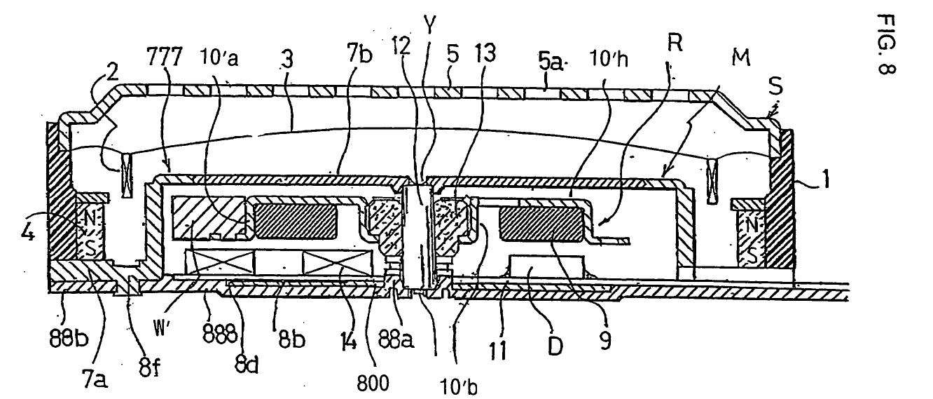

FIG. 8 shows another embodiment which is a variation of FIG. 6, having improved integration between a nonmagnetic end bracket and detent torque generation member. More specifically, a nonmagnetic end bracket 888 is at least twice as thick as a detent torque generation member 800 and has formed in a center thereof a shaft support portion 88a, the detent torque generation part 800 is press fitted onto the shaft support portion 88a at the center, and a cut-off tip 8d is embedded in the nonmagnetic end bracket 888. The shaft 12 is fixed on the shaft support portion 88a by laser welding from the outside. Here, a housing comprising the case 777 and nonmagnetic end bracket 888 is assembled by attaching the flanges 7a and 88b to each other by crimping together recesses and protrusions.

With such a constitution, sufficient shaft fixing strength can be maintained, and the detent torque generation member can be easily and securely disposed.

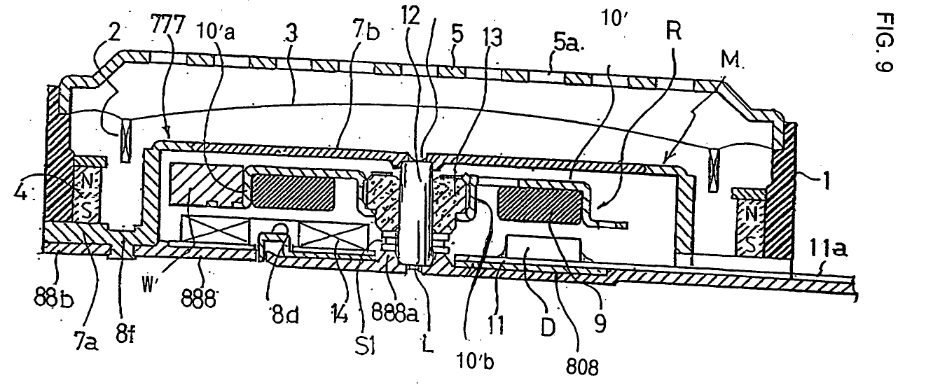

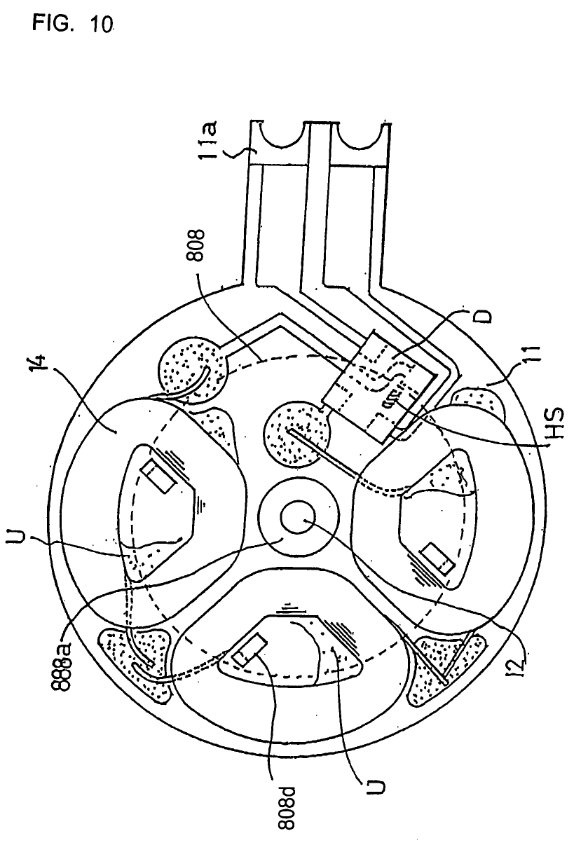

FIGS. 9 and 10 illustrate another embodiment relating to FIG. 8. Elements identical to those of the above embodiments are assigned the same reference symbols and explanation thereof is omitted.

The detent torque generation member 808 is attached to a nonmagnetic second bracket 888, and the shaft 12 is fitted in the shaft bearing portion 888a and laser welded at point L from the outside. The second bracket 888 is formed of nonmagnetic stainless steel with thickness of 0.15 mm-0.3 mm. A housing is constituted by the second bracket 888 and case 777, and the outer periphery 88b of the second bracket 888 overlaps with the flange 7a extending outward in the radial direction from the lateral periphery magnetic portion of the case 777, and is attached thereto by a recess and protrusion crimping portion 8f.

A detent torque generation part 808d is configured so that a tip thereof is positioned and fitted into the second bracket 888, and the outward portion in the radial direction is magnetically separated from the housing by mechanical separation.

A stator is constituted as follows. A stator base 11 comprising a printed wiring board is attached to the detent torque generation member 808. On the stator base 11, when the number of magnetic pole pieces of the magnet 4 of the rotor R to be assembled is 2n (n being an integer 2 or larger; here, the magnet is magnetized into four magnetic pole pieces alternatingly NS), there are provided, integrally with the stator base 11 and in the radial direction, a plurality (here, three) of single-phase wiring type air-core armature coils 14, an integrated-chip drive circuit member D with a sensor incorporated therein disposed on the stator base 11 so as not to overlap with the air-core armature coils 14 when seen from the plan view, and a feed terminal part 11a for input to the drive circuit member D.

The rotor R comprises the axial air-gap magnet 9 having a plurality (here, four) of magnetic pole pieces and the rotor yoke 10 holding the magnet 9, and is rotatably fitted, via the bearing 13 attached to the receiving portion in the center of the rotor yoke 10′, on the shaft 12 disposed on the shaft bearing portion 888a of the second bracket 888 of the stator and laser welded at point L from the outside.

Further, the rotor R is constituted such that the eccentric weight W′ is attached to a flange extending in the radial direction at an outer periphery of the rotor yoke 10′ by engaging recesses and protrusions, making the rotor R an eccentric rotor that causes centrifugal vibrations to be generated and allows the motor M to function as a vibration motor. The eccentric rotor R thus configured is rotatably fitted on the shaft 12 via three thrust washers S1 stacked so as to reduce brake loss.

The thrust washers S1 have different outer diameters. This is to avoid cases where, as in a case of washers with the same diameter, burrs interlock with each other, causing a clutch action and causing washers in a position of non-rotation to rotate.

The detent torque generation member 808 is made of magnetic stainless steel with thickness of 0.15 mm-0.3 mm (preferably 0.2 mm), and at a position within the air-core armature coil separated in the radial direction from the shaft bearing portion 1a in the center of the detent torque generation member 808 and situated at an angle opening of at least 15° (here, roughly 17°) from the center of each coil, the detent torque generation part 808d protrudes upwardly through the stator base 11 to an extent not exceeding the upper surface of the coil 14. Three air-core armature coils 14 are eccentrically disposed with an opening angle of 90° and the magnet 9 of a rotor to be assembled comprises four magnetic pole pieces. The positional relationship of the detent torque generation parts 8d and single-phase air-core armature coils 14 is set so that the opening angle of the effective conduction portions of the air-core armature coils 14 is as wide as possible, corresponding to the magnetic pole pieces of the magnet (described below), and the shape of the detent torque generation part 808d, as well as the size thereof, is preferably set so as to attain the minimum stop torque when stopped by magnetism of the magnet 9.

Here, the reason for shifting the detent torque generation part 808d in the coil about 17° is so that, whether a magnetic pole piece peak has stopped or whether a neutral portion has stopped, no start error occurs because of the position of a sensor HS incorporated in the drive circuit member D coming to a neutral zone of the magnet. This angle may be widened up to about 22.5° so as to attain a greater effective conduction portion; however, because the problem may arise of coils having insufficient windings, suitable positions are selected with consideration given to impact on power.

With such a constitution, despite reduction in size of three single-phase wiring type air-core armature coils, sufficient start torque can be attained.

As described above, the present invention has a fixed shaft type constitution, but it may also be used in a rotary shaft constitution.

Various other modifications may be made in the invention without departing from the technological essence and spirit thereof. Therefore, the above described embodiments merely serve to illustrate the invention and should not be construed as limiting. The technological scope of the invention is defined in the claims and is not restricted by the detailed description of the invention.

1. A magnetic sound transducer comprising;
a speaker housing:
a flat brushless vibration motor disposed in a center of the speaker housing, the flat brushless vibration motor including:
a motor housing disposed in a center of the speaker housing and formed of a case and bracket
an eccentric rotor rotatable mounted about a motor axis in said motor housing;
said motor housing having a circumferential wall extending in an axial direction to encompassed said eccentric rotor;
said motor housing having a motor housing flange extending radially outward from said circumferential wall, said motor housing flange having an outer flange periphery attached to said speaker housing; and
a stator assembly mounted in said motor housing to drive said eccentric rotor;
a ring-shaped moving voice coil disposed radially outward from said circumferential wall and around the flat brushless vibration motor;
a diaphragm to which one end of the moving voice coil is attached, said diaphragm having an outer periphery attached to the speaker housing;
a ring-shaped excitation magnet disposed on the motor housing flange and defining a ring-shaped gap between said ring-shape excitation magnet and said circumferential wall of said motor housing, said voice coil being disposed in said ring-shaped gap
the motor housing including a magnetic body, forming at least a portion of said circumferential wall, for receiving a magnetic field of the excitation magnet such that a magnetic path is formed directing the magnetic field via said circumferential wall toward the moving voice coil; and
said motor housing having at at least one portion thereof a means for reducing influence of the magnetic field of the excitation magnet on said eccentric rotor.

2. The magnetic sound transducer according to claim 1, wherein said means for reducing influence of the magnetic field of the excitation magnet includes:
at least one part of the motor housing being nonmagnetic or weakly magnetic; and
said magnetic body forming an outer periphery of the circumferential wall and facing said moving excitation coil and being thereby interposed between an interior of the motor housing and the moving excitation coil.

3. The magnetic sound transducer according to claim 2, wherein the magnetic body forms at least a portion of said motor housing flange, and the excitation magnet is disposed on said magnetic body.

4. The magnetic sound transducer according to claim 3, wherein:
said eccentric rotor has a magnet directing a magnetic field into an axial air-gap between said eccentric rotor and said stator, said magnet having a plurality of magnetic, poles;
said eccentric rotor has a rotor yoke in which the magnet is fixed, a nonmagnetic eccentric weight disposed radially outward of the magnet and positioned at an outermost periphery of the eccentric rotor, and a shaft bearing portion disposed radially inward of the magnet;
the rotor yoke has a flat portion receiving a magnetic field of the magnet and an axial wall on an outer diameter side adjoining the flat portion;
the magnet is configured such that a surface conveying flux of the magnetic field is enclosed by the flat portion and an outer diameter surface is enclosed by the axial wall; and
said stator has a shaft and a shaft support portion supporting the eccentric rotor, a plurality of air-core armature coils disposed about a periphery of the shaft support portion so as to oppose the eccentric rotor across said axial air-gap, and a stator base in which an IC drive circuit member driving the air-core armature coils is disposed.

5. The magnetic sound transducer according to claim 1, wherein said means for reducing influence of the magnetic field includes said case having a ceiling portion disposed adjacent said eccentric rotor and at least a part of said ceiling portion being formed of a nonmagnetic or weakly magnetic body, and joined to said magnetic body of said circumferential wall.

6. The magnetic sound transducer according to claim 5, wherein:
said eccentric rotor has a magnet directing a magnetic field into an axial air-gap between said eccentric rotor and said stator, said magnet having a plurality of magnetic poles;
said eccentric rotor has a rotor yoke in which the magnet is fixed, a nonmagnetic eccentric weight disposed radially outward of the magnet and positioned at an outermost periphery of the eccentric rotor, and a shaft bearing portion disposed radially inward of the magnet;
the rotor yoke has a flat portion receiving a magnetic field of the magnet and an axial wall on an outer diameter side adjoining the flat portion;
the magnet is configured such that a surface conveying flux of the magnetic field is enclosed by the flat portion and an outer diameter surface is enclosed by the axial wall; and
said stator has a shaft support portion supporting the eccentric rotor, a plurality of air-core armature coils disposed about a periphery of the shaft support portion so as to oppose the eccentric rotor across said axial air-gap, and a stator base in which an IC drive circuit member driving the air-core armature coils is disposed.

7. The magnetic sound transducer according to claim 1, wherein:
said eccentric rotor includes a magnet; and
said means for reducing influence of the magnetic field includes said case having a ceiling portion disposed adjacent said eccentric rotor and said ceiling portion has an inner concaved portion facing said eccentric rotor and concaved in the axial direction away from said eccentric rotor, said inner concaved portion having a diameter about equal to or greater than an outer diameter of said magnet of said rotor.

8. The magnetic sound transducer according to claim 7, wherein:
said eccentric rotor has an auxiliary plate and an eccentric weight;
said auxiliary plate is accommodated in a concavity defined by said inner concaved portion; and
said eccentric weight is partially held down by an outer periphery of the auxiliary plate.

9. The magnetic sound transducer according to claim 1, wherein:
said eccentric rotor includes a magnet; and
said means for reducing influence includes the eccentric rotor having a magnetic balance disposed outward of the magnet and concentric with a rotation center of the magnet.

10. The magnetic sound transducer according to claim 9, wherein:
said eccentric rotor includes a rotor yoke supporting the magnet; and
said magnetic balance is a brim portion protruding in the radial direction along the entire periphery of said rotor yoke; and
said eccentric rotor includes an arc-shaped nonmagnetic eccentric weight attached to the brim portion by combining a recess and protrusion.

11. The magnetic sound transducer according to claim 10, wherein:
said eccentric rotor has the magnet directing a magnetic field into an axial air-gap between said eccentric rotor and said stator, said magnet having a plurality of magnetic poles;
said eccentric rotor has a rotor yoke in which the magnet is fixed, a nonmagnetic eccentric weight with a specific gravity of at least 17 disposed radially outward of the magnet, and a bearing disposed radially inward of the magnet;
the rotor yoke has a flat portion receiving a magnetic field of the magnet and an axial wall on an outer diameter side adjoining the flat portion;
the magnet is configured such that a surface conveying flux of the magnetic field is enclosed by the flat portion and an outer diameter surface is enclosed by the axial wall,
said eccentric rotor has an auxiliary plate has an outer diameter concentric to the motor axis in order to attain a magnetic balance and the eccentric weight and the bearing are partially held down by the auxiliary plate; and
said stator assembly includes a stator base on which are disposed a shaft supporting the eccentric rotor, a plurality of air-core armature coils driving the eccentric rotor and a drive circuit member.

12. The magnetic sound transducer according to claim 1, wherein:
said stator assembly includes a detent torque generation part for applying a detent torque to said eccentric rotor; and
said means for reducing influence from the magnetic field of the excitation magnet includes said detent torque generation part being disposed on the bracket and magnetically separated from a magnetic field of the excitation magnet by a gap in magnetic material of said motor housing.

13. The magnetic sound transducer according to claim 10, wherein;
said stator assembly includes a plurality of detent torque generation parts provided radially outward from the motor axis with a magnetization angle separation roughly equivalent to, or an integral multiple of, an angle of said magnetic poles of the magnet; and
said stator assembly includes a nonmagnetic end bracket, as a magnetic separation means, forming said bracket and said detent torque generation parts being supported by said nonmagnetic end bracket separated from the magnetic body of the housing.

14. The magnetic sound transducer according to claim 12, wherein said bracket is a nonmagnetic end bracket formed of nonmagnetic metal, said detent torque generation part is attached thereto, and said nonmagnetic end bracket provides said gap in magnetic material.

15. The magnetic sound transducer according to claim 14, wherein the nonmagnetic end bracket is thicker than the detent torque generation part and has a shaft support portion formed in a center thereof, and the detent torque generation part has a center press fitted on the shaft support portion and a cut-off tip is embedded in the nonmagnetic end bracket.

16. The magnetic sound transducer according to claim 1, wherein:
said stator assembly includes a detent torque generation member made from a magnetic plate and an end bracket to which the detent torque generation member is attached, the detent torque generation member further having attached thereto a shaft bearing portion disposed in a center thereof, and at least two detent torque generation parts disposed extending outwardly in radial direction, the at least two detent torque generation parts having torque generating protruding portions which protrude in a axial direction toward said eccentric rotor;
said stator assembly includes:
a stator base including a printed wiring board;
at least two air-core armature coils single-phase wired and fixed to the stator base;
a drive circuit member disposed on the stator base so as not to overlap with the air-core armature coils in a direction parallel to said motor axis, said stator member driving said air-coil armatures; and
said stator base including a feed terminal for input to the drive circuit member;
said eccentric rotor includes a magnet having a plurality of magnetic poles and a rotor yoke holding the magnet, said eccentric rotor being rotatably fitted to the stator assembly via a shaft;
said torque generating protruding portions protrude within air cores of the air-core armature coils; and
the detent torque generation member is separated from the magnetic body of the circumferential wall by nonmagnetic material as means for reducing influence from the magnetic field of the excitation magnet on said eccentric rotor.
